(19) United States
(12) Patent Application Publication
(10) Pub. No.: US 2025/0367667 A1
(43) Pub. Date: Dec. 4, 2025

(54) TEST SYSTEM, DETECTION DEVICE, TEST METHOD AND TEST PREPARATION MEANS

(71) Applicant: MIDGE MEDICAL GMBH, Berlin (DE)

(72) Inventors: Steffen ZINN, Berlin (DE); Jesus BUENO, Berlin (DE); Phil GÖTTSCHING, Berlin (DE); Christian WAHNES, Berlin (DE); Michael DIEBOLD, Berlin (DE)

(21) Appl. No.: 18/878,209

(22) PCT Filed: Jun. 23, 2023
(86) PCT No.: PCT/EP2023/067196

§ 371 Date: Dec. 23, 2024

(30) Foreign Application Priority Data
Jun. 24, 2022 (DE) 102022115872.1

(51) Int. Cl. B01L 3/00; B01L 7/00

(52) U.S. Cl. CPC B01L 3/50851; B01L 7/52; B01L 2200/147; B01L 2300/023; B01L 2300/0663

(57) ABSTRACT

The invention relates to a test system, a detection device for simultaneous test of samples contained in different test containers and a test container assembly comprising a single lysing chamber and a dosing assembly that is selectively fluid connected to the lysing chamber and that comprises a plurality of dosing compartments for dosed and simultaneous transfer of equal portions of a lysed sample from the lysing chamber into test vials.

The invention relates to a testing system, a testing device, a testing method and test preparation means that serve for detecting a target analyte, in particular a target nucleic acid, for instance DNA or RNA, by way of isothermal nucleic acid amplification and fluorescence.

Nucleic acid amplification technologies are used to amplify the amount of a target nucleic acid in a sample in order to detect such target nucleic acid in the sample. A known nucleic acid amplification technology is Polymerase Chain Reaction (PCR). Isothermal nucleic acid amplification technologies offer advantages over polymerase chain reaction (PCR) in that they do not require thermal cycling or sophisticated laboratory equipment.

Known isothermal nucleic acid amplification technologies are inter alia Recombinase Polymerase Amplification (RPA) and Strand Invasion Based Amplification (SIBA) and other methods known to persons skilled in the art.

Recombinase polymerase amplification (RPA) is a known method for amplifying the amount of a target analyte, in particular a nucleic acid such as DNA or RNA in a sample. For recombinase polymerase amplification three core enzymes are used: a recombinase, a single-stranded DNA-binding protein (SSB) and a strand-displacing polymerase. Recombinases can pair oligonucleotide primers with homologous sequences in duplex DNA. SSB binds to displaced strands of DNA and prevents the primers from being displaced. The strand-displacing polymerase begins DNA synthesis at sites where the primer has bound to the target DNA. Thus, if a target gene sequence is indeed present in the tested sample, an exponential DNA amplification reaction can be achieved to amplify a small amount of a target nucleic acid to detectable levels within minutes at temperatures between 37° C. and 42° C.

The three core RPA enzymes can be supplemented by further enzymes to provide extra functionality. Addition of exonuclease III allows the use of an exo probe for real-time, fluorescence detection. If a reverse transcriptase that works at 37 to 42° C. is added then RNA can be reverse transcribed and the cDNA produced amplified all in one step.

By adding a reverse transcriptase enzyme to an RPA reaction, it can detect RNA as well as DNA, without the need for a separate step to produce cDNA. It is an advantage of RPA that it is isothermal and thus only requires simple equipment. While RPA operates best at temperatures between 37° C. and 42° C. it still works at room temperature.

For detecting the presence of a targeted nucleic acid in a sample, fluorescence detection technique can be used. After the light source at specific wavelength illuminates on the targeted nucleic acids, the DNA-binding dyes or fluorescein-binding probes of the nucleic acids will react and enable fluorescent signals to be emitted. The fluorescent signal is an indication of the existence of the targeted nucleic acids.

The present invention relates to a fast and easy to handle method for isothermal amplification of nucleic acids, including DNA and RNA. Particularly, the invention relates to diagnostic methods for rapidly diagnosing, for example, at least two infectious agents, or at least two different targets in the same infectious agent, in a biological sample of interest. The invention further relates to a handheld and portable diagnostic system for performing the amplification method in a laboratory as well as in a non-laboratory environment.

Nucleic acid amplification techniques (NAATs), like molecular real-time PCR assays, are usually very sensitive, and specific but when it comes to time-to-result, PCR still has the inherent disadvantage to require highly-equipped laboratories and well-trained personnel. Therefore, new portable diagnostic solutions having a good specificity and sensitivity and being able to provide reliable results in situ at the place of testing are urgently needed.

Regarding nucleic acid-based preparative, cloning and diagnostic techniques, the development of polymerase chain reaction (PCR) in the 1980^{ies} by the later Nobel laureate Kary Mullis and team as rapid and reliable method to amplify DNA revolutionized molecular biology in general, as scientists suddenly had the opportunity to obtain millions of copies of a DNA target molecule of interest in short time. Simplicity and efficiency (e.g., nowadays possibilities to perform single-molecule/cell PCR) represent significant advantages of PCR techniques.

Still, PCR suffers from certain drawbacks, including the inherent need for iterative rounds of thermal cycling and the shift between different temperatures (repeated cycles of two or three temperature-dependent steps during the amplification process) and the use of high (>90° C.) temperatures. These drawbacks have led to the development of alternative amplification methods.

An important class of PCR alternatives are so called isothermal amplification methods (for a review, see Zanoli and Spoto, Biosensors (Basel), 2012 3(1): 18-43)). The huge advantage over PCR is the fact that isothermal nucleic acid amplification methods are not requiring any thermal cycling at all, but can be conducted at constant temperatures. This makes the amplification process much easier to operate and to control. Further, less energy is needed than for PCR methods, the latter inherently requiring rapid heating and cooling steps. The constant temperature of isothermal methods additionally allows fully enclosed micro-structured devices into which performing the isothermal amplification reduces the risk of sample contamination and implies low sample consumption, multiplex DNA analysis, integration and portable devices realization. Finally, the constant temperature would be highly preferably for point-of-need and/or portable diagnostic devices, as recently developed by the present applicant (DE 10 2020 109 744.1 which is incorporated herein by reference).

Isothermal amplification strategies available at date include nucleic acid sequence-based amplification (NASBA), loop-mediated isothermal amplification (LAMP), helicase-dependent amplification (HDA), rolling circle amplification (RCA), multiple displacement amplification (MDA), recombinase polymerase amplification (RPA) (see again: Zanoli and Spoto, 2012, supra; for a comprehensive survey on nowadays RPA techniques: Li et al., Analyst, 2019, 144, 31, pp. 31 to 67), or strand invasion based amplification (SIBA®—SIBA in the following) (Hoser et al., PLOS ONE 9(11): e112656. doi: 10.1371/journal.pone.0112656). Still, just as PCR isothermal technologies too, tend to produce non-specific amplification products as major drawbacks.

Whereas, for example, NASBA, RPA and HDA (and certain kinds of quantitative PCR) rely on the use of target-specific probes to provide for higher specificity of the reaction, LAMP uses additional primers instead of probes together with a strand displacement polymerase (Notomi et al., 2000, Nucleic Acids Research 28: e63). The use of numerous large primers in an at least 30 min incubation, however, has been shown to produce false-positive results—an outcome definitely to be avoided during diagnostic applications, particularly for diagnosing infectious diseases. Further, there is the problem that LAMP reactions require a high temperature of 65° C., which is unfavourable for diagnostic devices for use in a home environment due to regulatory and practical issues. Consequently, LAMP will not be the method of choice in case a diagnostic nucleic acid amplification result is needed in a short time in a handheld device, which has to fulfill certain regulatory requirements to be suitable for non-laboratory use.

RPA and SIBA technology both rely on the use of a recombinase during the binding and amplification process. Initially, a nucleoprotein complex constituted by oligonucleotide primers and the recombinase proteins is formed for RPA-and SIBA-type nucleic acid amplification strategies, these complexes facilitating the primer binding to the template DNA. Due to their short run times (around 15 min), unspecific amplification has not been observed. A certain advantage is the fact the recombinase can tolerate at least one incorrect base without preventing strand invasion necessary to start the reaction.

In parallel to the biochemical advancements in nucleic acid amplification, also the development of devices including suitable reaction and detection chambers for performing nucleic acid amplification in an optimized manner have steadily developed. A great trend has been the development of microfluidic devices and, in general, a trend of miniaturizing or “nanotizing reaction chambers”, i.e., putting them into nanoforms, has been of great interest to decrease the sample volumes and thus the amount of reagents needed and to achieve advantages in biochemical detection, time to result, faster thermal transfer, and to have the potential for automation and integration and, what is more, to have the possibility of multiplexed or multimeric tests. Multimeric in this case means multiplexing in the sense of parallel reactions being conducted in separate (locally distinct) reaction chambers.

It is observed that rapid testing for more than one pathogen or target sequence becomes of great importance. For cost reasons, double testing is usually not performed by general practitioners usually being the first physicians diagnosing patients with symptoms of suspected respiratory disease. Also regarding prophylactic testing of potentially contaminated surfaces, or of returnees from travels abroad, it is frequently observed that testing is conducted too late (when symptoms of the disease become apparent), or standardized testing which would allow a targeted decontamination of surfaces etc. is not performed regularly in view of the costs involved for PCR tests.

A testing system, different containers containing reagents to be used in a system and a testing device for detecting a target analyte are disclosed in WO 2021/204900 A1 and WO 2021/204901. The prior art detection device comprises a detection chamber that can receive a container containing reagents for detecting a target analyte. Within the detection chamber or adjacent to the detection chamber, a light source and an optical sensor are arranged. For detecting a target analyte, the light source illuminates the contents of the detection chamber with a light that can cause luminescence in a sample to be tested during and after the sample has undergone recombinase polymerase amplification. The optical sensor is arranged and configured to detect luminescence in the detection chamber in case luminescence occurs.

WO 2019/060950 A1 discloses a diagnostic test system, including: a diagnostic test assembly and a diagnostic test apparatus to perform a test on a biological or environmental sample. The diagnostic test assembly includes: a sample preparation reservoir to receive the sample into a sample preparation fluid, such that a swab carrying the sample can be used to stir the preparation fluid and to wash the swab; a sample dispensing mechanism for insertion into the sample preparation reservoir; a closure to seal the sample preparation reservoir; at least one diagnostic test reservoir coupled to the sample preparation reservoir; and at least one seal between the sample preparation reservoir and the diagnostic test reservoir to prevent fluid movement between the respective reservoirs. The sample dispensing mechanism is operable to disrupt the seal to allow sample fluid to enter the diagnostic test reservoir from the sample preparation reservoir, and to dispense a predetermined amount of fluid.

It is an object of the invention to provide means that allow an easy to use and fail-save testing of a sample for different biological analytes.

It is thus an object to provide a test system, a detection device and a test method for simultaneous testing for different target analytes, in particular DNA or RNA target sequences, that can be conducted under non-laboratory conditions as well as under laboratory conditions in a preferably handheld or at least portable diagnostic device to enable point-of-care diagnostic of infections even under a home or a point of care environment and to provide fast and reliable diagnostic results for diagnosing several potential infections and/or target nucleic acids in preferably one and the same test sample directly applied to the diagnostic device. The device should be configured in such a way that an easily customizable test for at least two target sequences should be provided, wherein the device allows that the biochemical reactions performed can be exchanged easily to be adapted to the diagnostic needs of the customer interested in the relevant results.

In particular, it is an object of the invention to facilitate the testing of samples by means of nucleic acid amplification technology.

According to a first aspect of the invention, a test system is provided that comprises a detection device with a plurality of detection chambers for receiving test containers containing a sample to be tested and a mixture of chemicals including target-specific probes and enzymes that can cause an amplification of nucleic acid in a sample. Testing for different target nucleic acids requires different probes and thus different test containers.

According to a second aspect of the invention a test container assembly comprising a single lysing chamber and dosing means for dispensing a definite amount of fluid from the lysing chamber to individual test containers. The lysing chamber contains a liquid lysing fluid that causes lysing of the cells in a sample to thus release the nucleic acids (DNA or RNA) is provided. The lysing fluid may comprise an acid, e.g. HCl or a weak alkali, and a surface active agent.

Each test container contains a mixture of chemicals that can cause an amplification of nucleic acid in a sample. Preferably, the mixture comprises including target-specific probes and enzymes, in particular a recombinase, a single-stranded DNA-binding protein (SSB) and strand-displacing polymerase that causes a recombinase polymerase amplification (RPA). The test container further preferably contains exonuclease III allowing the use of an exo probe for real-time, fluorescence detection. The mixture may be provided in form of a dry pellet.

One aspect of an easy to use, fail safe testing system for simultaneous testing of a sample for different target nucleic acids, is provided by a dosing assembly that comprises one lysing chamber and dosing means.

According to a third aspect of the invention a detection device is provided.

The detection device comprises
a plurality of detection chambers with at least one detection chamber body enclosing the detection chambers, each detection chamber being configured to accommodate a test container,
one or more light sources, one or more optical sensors,
temperature control means,
a battery,
a data communication interface and
a controller.

Preferably, the thermal capacity of the at least one detection chamber body corresponds to five to hundred times the thermal capacity of fluid samples in the test containers. Preferably, the sample volume in a test container is 50 μl/0,05 gr. The specific heat capacity of a sample corresponds to water, i.e. 4184 J/kg*K.

A test system according to the first aspect preferably comprises a detection device with a plurality of detection chambers for receiving test containers containing a sample to be tested and a mixture of chemicals including target-specific probes and enzymes that can cause an amplification of nucleic acid in a sample. The detection device further comprises a controller, a memory and a data communication interface. The memory and the data communication interface are operative connected to the controller.

The test system further comprises a test container assembly comprising a plurality of test containers containing a sample to be tested and a mixture of chemicals including target-specific probes and enzymes that can cause an amplification of nucleic acid in a sample. According to a preferred embodiment, one of the containers contains a reference or control assay that always will cause luminescence if the test system is handled correctly and the test procedure is performed without fault.

The test system preferably further comprises a smart communication device being configured for wireless data communication with the detection device.

The test system preferably comprises a detection device as described hereinafter.

The detection device according to the third aspect preferably comprises
a plurality of detection chambers for receiving test containers,
at least one light source arranged and configured to illuminate at least one detection chamber for causing luminescence in a sample to be tested,
at least one light sensor for each detection chamber configured to detect luminescence in a sample to contained in test container placed in a respective detection chamber,
a controller and
a memory connected to the controller.

Optional further components of the detection device include a temperature sensor, an inertia measurement unit, heating means and a status indicating light.

The light sensors and the at least one light source are arranged to allow illumination of a contents of a detection chamber by means of the at least one light source and detecting luminescence in a respective detection chamber by means of the respective light sensor assigned to the defection chamber while preventing light emitted by the light source or the light sources from directly illuminating any of the light sensors. The light sensors and the at least one light source are preferably arranged lateral with respect to the detection chamber and the test container, respectively, so as to avoid a negative influence of particles settling on the bottom of the test container on the light signal to be measured by the respective light sensor.

The controller is at least indirectly connected to the light source and to the light sensors for controlling the at least one light source and for controlling the read out of output values of the light sensors. In particular, the controller may be adapted by means of software stored in the memory and by means of driver circuitry for the light sources and the light sensors to control illumination of a respective detection chamber by way of the light source and to read out the output signal of the light sensor.

The light sources preferably are multi color light sources, for instance multi color LEDs that can be controlled by the controller with respect to the color (band of wavelengths) emitted by the respective light source and with respect to the intensity of the emitted light.

The memory comprises software defining the operation of controller. The software stored in the memory may include a device operation system that allows controlling of the device electronic components by way of the controller.

The software stored in the memory may further include a script interpreter adapted to interpret script commands stored in the memory. Preferably, the script commands are part of a script that defines a test procedure that is adapted to a particular assay or assays contained in the test containers. Accordingly, the memory preferably comprises software defining a script interpreter and the detection device preferably is configured to receive script commands that, when interpreted by the script interpreter and executed by the controller, define a test procedure.

The memory is further adapted to store at least parameter values corresponding to output values of the light sensors. Further parameter values to be may be output values of a temperature sensor and/or output values of an inertia measurement unit.

The detection device preferably comprises heating means for controlling the temperature in the detection chambers. The heating means preferably are configured for maintaining a predetermined temperature in the detection chambers within a temperature range of +/−0.5 K about the predetermined temperature, said heating means being controlled by controller. The predetermined temperature preferably is a temperature between 40° C. and 45° C., preferably 42° C.

The detection device preferably further comprises a metal block that that is thermally coupled to the heating means and that at least in part encloses the detection chambers, said metal block being arranged and configured to provide a uniform heat distribution. The metal block thermal mass corresponds to the power of the heating means in order to achieve suitable temperature gradients during heating and during keeping the temperature more or less constant when the temperature is feedback controlled. In other words: the thermal mass of the metal block is chosen to allow a stable feedback control of the temperature of the detection chambers.

The detection device preferably further comprises a temperature sensor for determining a temperature corresponding to the temperature in at least one of the detection chambers. The temperature sensor allows feedback control of the temperature in the detection chambers.

The detection preferably further comprises a wireless data interface for wirelessly transmitting and receiving data to and from a smart communication device. As disclosed in further detail hereinafter, data communication with a smart communication device facilities the use of the detection device in many respects.

The detection device preferably further comprises a status indicating light that is operatively connected to the controller. The detection device preferably is configured to indicate via the status indicating light only the current status of the detection device, for instance “Device is rebooting”, “Device is in ERROR state”, “Device is plugged to power supply”, “Device is out of battery”, “Detection device and smart communication device are trying to connect”, “Detection device and smart communication device are trying to connected”, “Device is Preheating”, “Preheating is completed”, “Test procedure is ongoing” and/or “Test procedure is completed. Result Analysis is ongoing”.

Test results, user prompts etc. are preferably indicate via the application on the smart communication device and the display of the smart communication device.

According to a fourth aspect of the invention, a method of operating a test system is provided.

The method of operating a test system preferably comprises at least some of the steps of
providing a detection device according to one of those described herein,
providing a test container or a test container assembly as describe hereinafter,
providing a smart communication device,
activating the detection device,
coupling the detection device with the smart communication device (in case coupling is needed; this step thus is optional),
configuring the detection device by
   reading a code from the test container or the test container assembly representing an ID of the assay or identifying a test procedure and/or a script defining a test procedure (this is preferred because the detection device thus can be an universal device that can be adapted to individual test procedures and assays; in an alternative embodiment, the detection device is preconfigured for a certain test procedure suiting a certain assay. In the latter no reading of code from the test container or the test container assembly is needed. In alternative embodiment of a universal (i.e. programmable) detection device, the test procedure can be configured manually.)
   uploading a script comprising script commands defining a test procedure to be performed by the detection device, the script and the test procedure defined thereby corresponding to an assay in the test container or the test container assembly (again, this step is optional; see above) and
placing the test container or the test containers of the test container assembly in one or more detection chambers of detection device (the sequence of the steps of configuring the detection device and of placing test containers in detection chamber is optional; however, first configuring the detection device and only then placing the test containers in the detection chambers is preferred as it allows automatic starting of the test procedure by inserting the test containers in the receptacles (detection chambers) of the detection device)
automatic start of the test procedure defined by the uploaded script once the test container or the test containers of the test container assembly are placed in the detection chamber(s) (the automatic start is preferred; in alternative embodiments, starting the test procedure is triggered manually, for instance via a graphical user interface on a smart communication device),
storing parameter values obtained during the test procedure in a memory of the detection device,
reading out the parameter values obtained during the test procedure from the memory of the detection device by means of the smart communication device uploading the parameter values obtained during the test procedure to a server.

The steps of reading and of out the parameter values uploading the parameter values to a server are optional because the test result typically is immediately indicated to a user by a status indicating light of the detection device or a message on a smart communication device at the end of a respective test procedure.

The configuration of the detection device and the start of the test procedure may be fully automatic in case the test container or the test container assembly is provided with an ID code that can be read out by the detection device itself. For instance, the test container or the test container assembly can be provided with a RF-ID chip that can be read out by a NFC-interface of the detection device when the test container or the test container assembly is placed in the receptacles of the detection device. Then, configuration of the detection device and starting the test procedure can occur automatically once the test container or the test container assembly is placed in the detection chambers.

Preferably, the parameter values obtained during the test procedure are analyzed by the server. In particularly preferred embodiment, the server is configured to conduct cluster analyses of the parameter values obtained during the test procedures of different detection devices.

The method preferably further comprises the step of encrypting the obtained parameter values stored in memory.

The method preferably further comprises the step of deleting script commands in memory once the test procedure is completed.

The test container assembly according to the fourth aspect can comprise a single lysing chamber, a plurality of test containers and dosing means. The dosing means are selectively fluid connected to the lysing chamber and that comprise a plurality of dosing compartments for dosed and simultaneous transfer of equal portions of a lysed sample from the lysing chamber into test containers.

The dosing means may comprise
volumetric dosing compartments and/or
microfluidic sample distribution means.

Dosed distribution of a lysed sample liquid thus may be achieved
by volumetric dosing assembly and/or
by microfluidic sample distribution and dosing.

The dosing compartments of the dosing assembly each preferably have at least one flow-in opening and at least one flow-out opening. The flow-in opening and the flow-out opening can be selectively closed and opened. The dosing assembly comprise manually operated control means for selectively opening and closing the inflow openings and the outflow openings

The dosing assembly preferably is integrated in the container assembly comprising the lysing chamber.

The dosing assembly may comprise a disc that can be rotated. In one rotational position of the disc the dosing compartments are open towards the lysing chamber and in a different rotational position the dosing compartments have open outflow openings so as to release the contents of the dosing compartments towards the different test containers.

In a test system, the number of dosing compartments preferably corresponds to the numbers of detection chambers of the detection device.

If for instance four detection chambers and thus four test containers are provided, the disclike part of the dosing assembly may be configured to be rotated by a little less than a quarter of a full turn.

In one embodiment, the dosing compartments are additionally fluidly connected with respect to the lysing chamber, i.e. the dosing compartments are open towards the lysing chamber. In order to achieve a homogenous distribution of the sample in the lysing chamber and the dosing compartments, it is preferred if the dosing compartments have a large opening towards the lysing chamber.

In an alternative embodiment, the dosing compartments initially are fluidly separated from the lysing chamber. After lysing, the dosing compartments are fluidly connected to the lysing chamber. For example, a rotating or otherwise moving part of the dosing assembly would open a fluid connection between the lysing chamber and each dosing compartment. For instance, the lysing chamber with respect to the dosing compartments can be rotated in a position wherein an outflow port of the lysing chamber is in line with an inflow opening of a respective dosing compartment.

According to different preferred embodiments, rotation may be caused by manual actuation or by a motor in the testing device. The rotation preferably is a quarter turn if four dosing compartments are provided.

Further rotation would close the fluid connection between the lysing chamber and the dosing compartments and even further rotating would open the outflow opening of the dosing compartments with respect to the test chambers.

The dosing compartments could be cavities and/or openings in a disc-like member of the dosing assembly that is placed between a bottom of the lysing chamber and a bottom of the container comprising the lysing chamber and the dosing assembly.

In an alternative embodiment, the test container assembly may be similar to a syringe with the four dosing compartments arranged at the bottom of the syringe. Initially, these dosing compartments are open with respect to the lysing chamber. Moving a piston towards the dosing compartments would first close the dosing compartments. Further moving the piston would then press the contents of the dosing compartments into the test chambers.

Preferably, the dosing means comprise flow control means that are configured for manual operation.

It has been found that obtaining reliable test results for different target analytes, in particular different target nucleic acids, is facilitated if a sample is lysed once and the lysed sample is simultaneously distributed to a plurality of test containers containing testing chemistry for different target analytes.

The system can either be a point of care (POC) system wherein the fluorescence detection device is arranged at a point of care, for instance in a medical doctor's office. Alternatively, the system may be a personal system wherein the fluorescence detection device is self-contained and mobile, in particular pocketable.

The test system and its components, i.e. the detection device, the smart communication device with the application installed thereon and the test container assembly allow an easy and fail-safe testing for analytes in a home and/or a point of care environment and do not need particularly educated personnel.

The invention shall now further be illustrated by way of an example and with a reference to the figures. Of the figures,

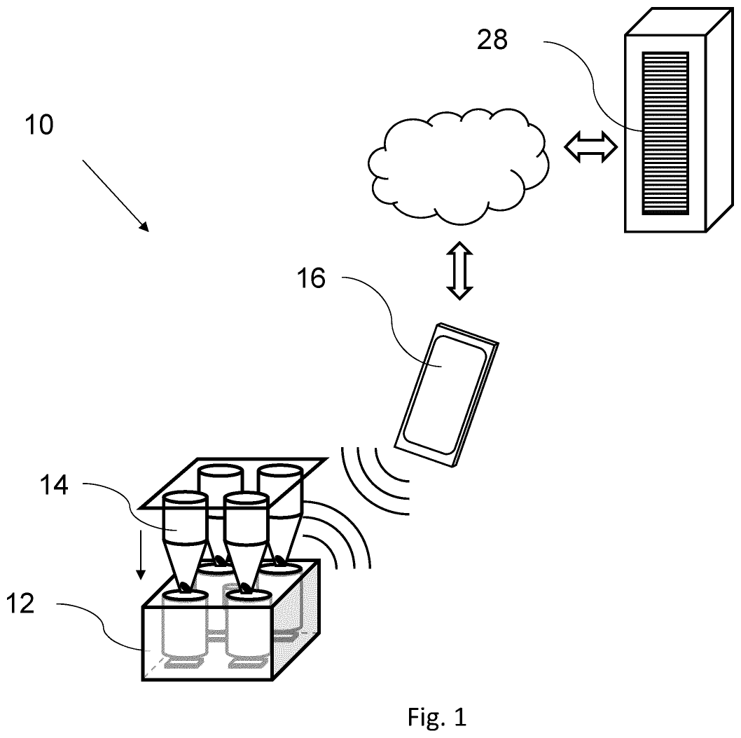

FIG. 1: illustrates components of a test system by way of example;

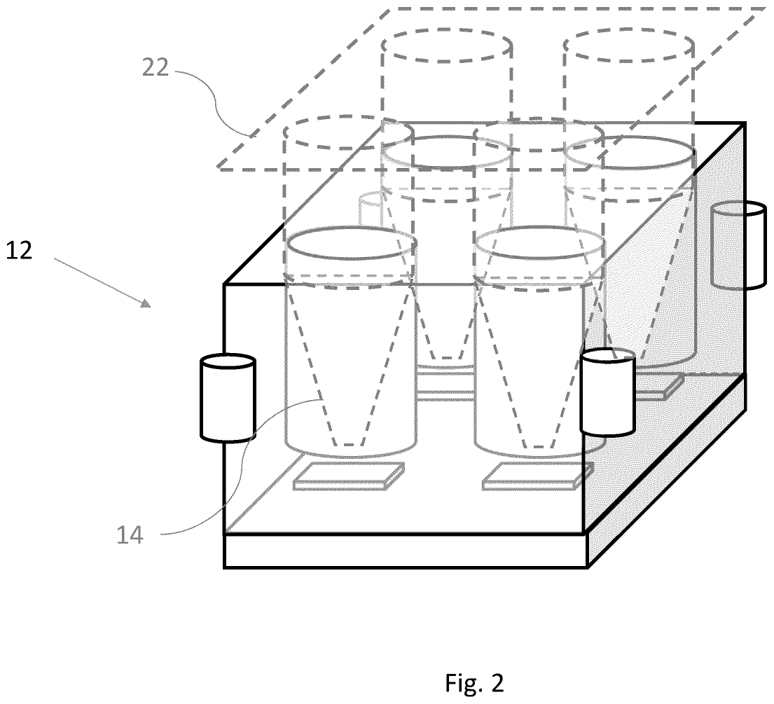

FIG. 2: is a schematic representation of a detection device and an indication, how test containers of a test container assembly can be placed in detection chamber formed by receptacles of the detection device;

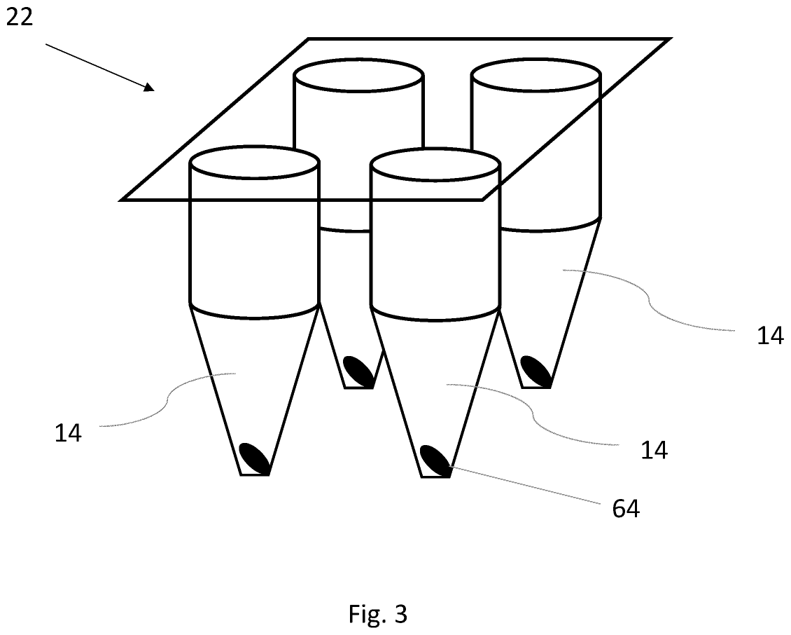

FIG. 3. is schematic representation of a test container assembly comprised of four test containers, i,e, vials containing a mixture containing enzymes for detecting a target nucleic acid;

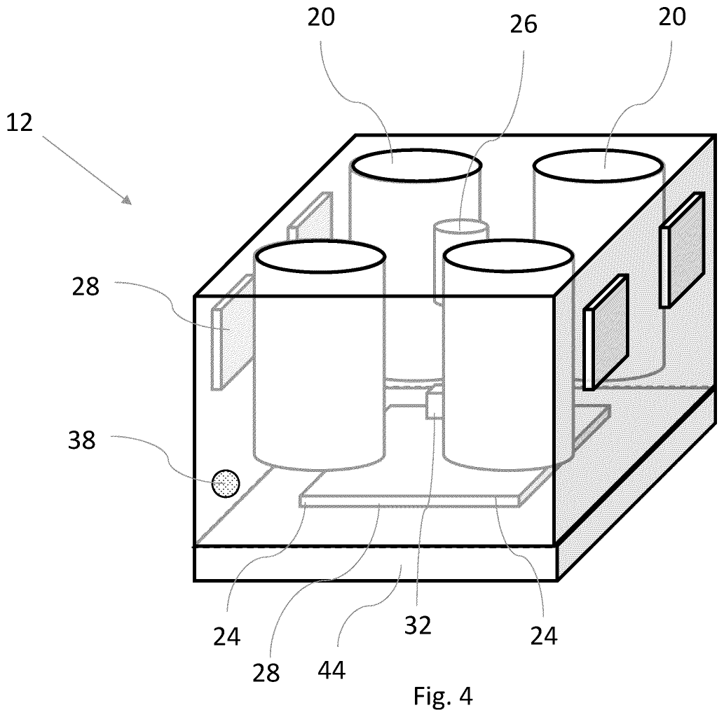

FIG. 4: is schematic representation of a detection device;

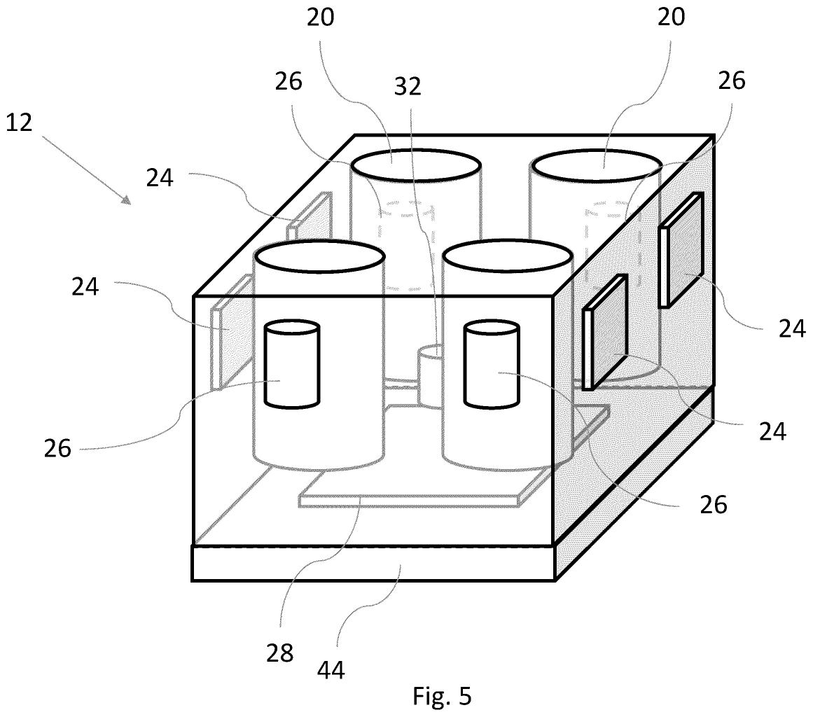

FIG. 5: is schematic representation of an alternative detection device similar to the testing device of FIG. 4 but with an individual light source for every detection chamber;

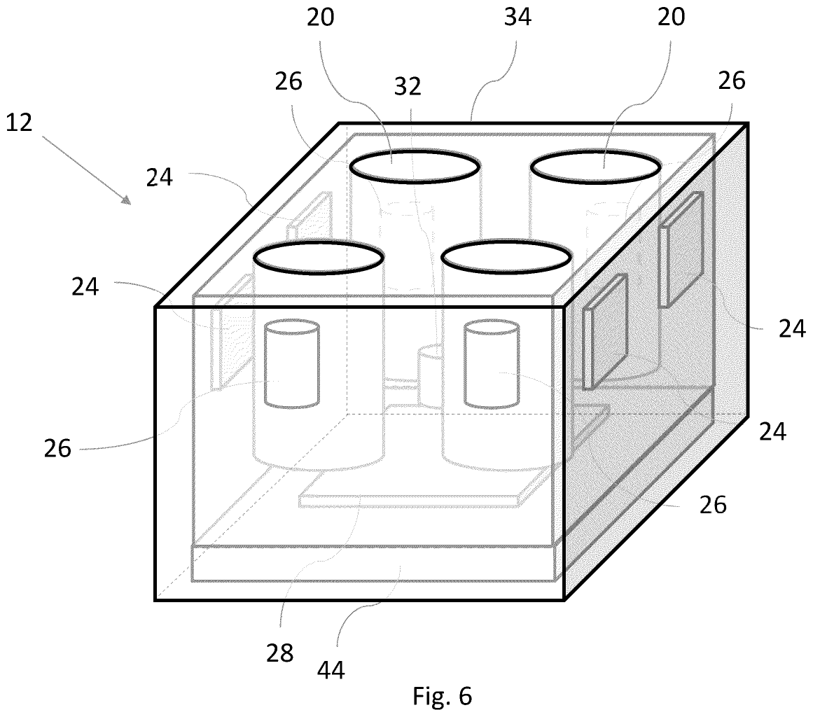

FIG. 6: is schematic representation of the alternative detection device of FIG. 5 showing a housing enclosing the components of the detection device

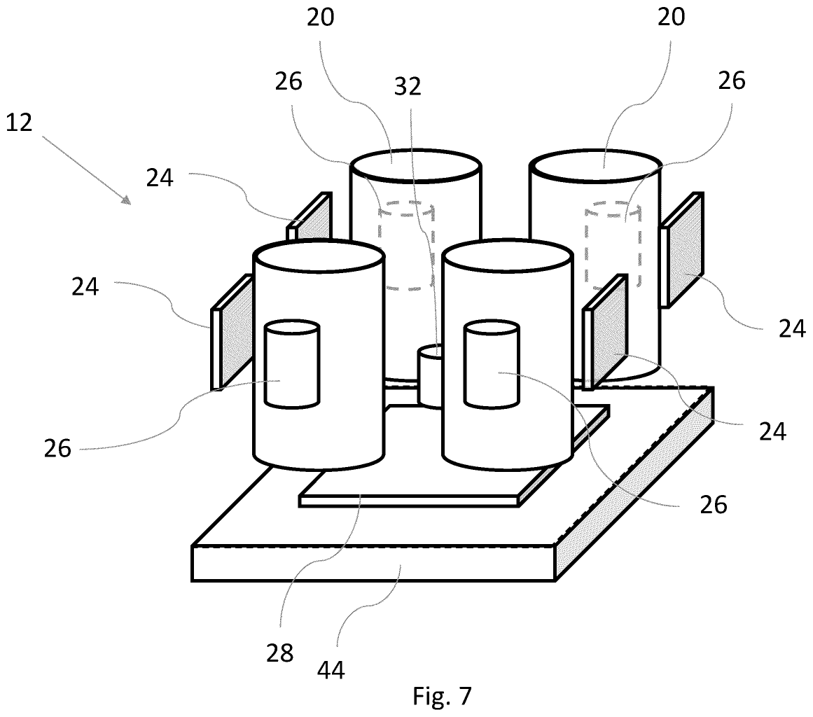

FIG. 7: is schematic representation of the alternative detection device of FIG. 5

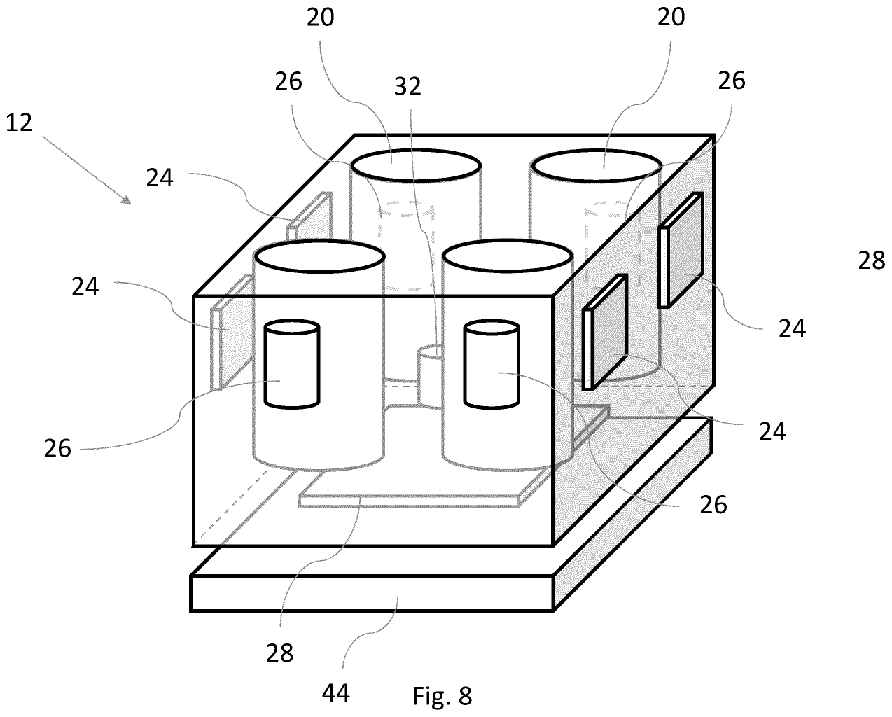

FIG. 8: schematically illustrates that the detection device may comprise a dedicated control module;

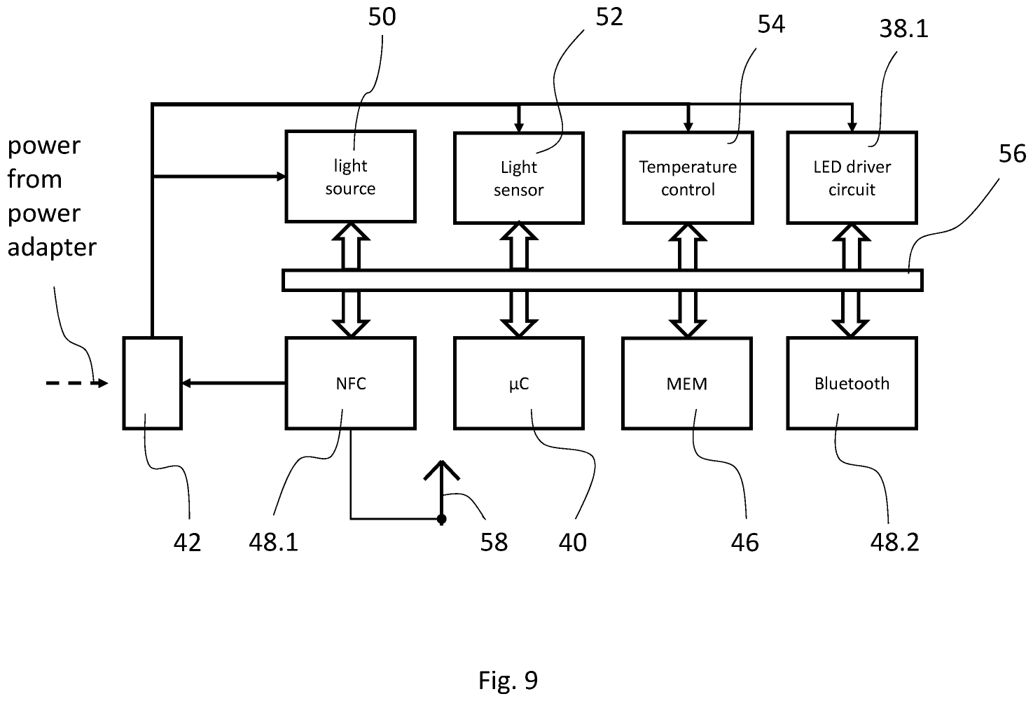

FIG. 9: schematically illustrates basic electronic components of the detection device that can be implemented as a control module;

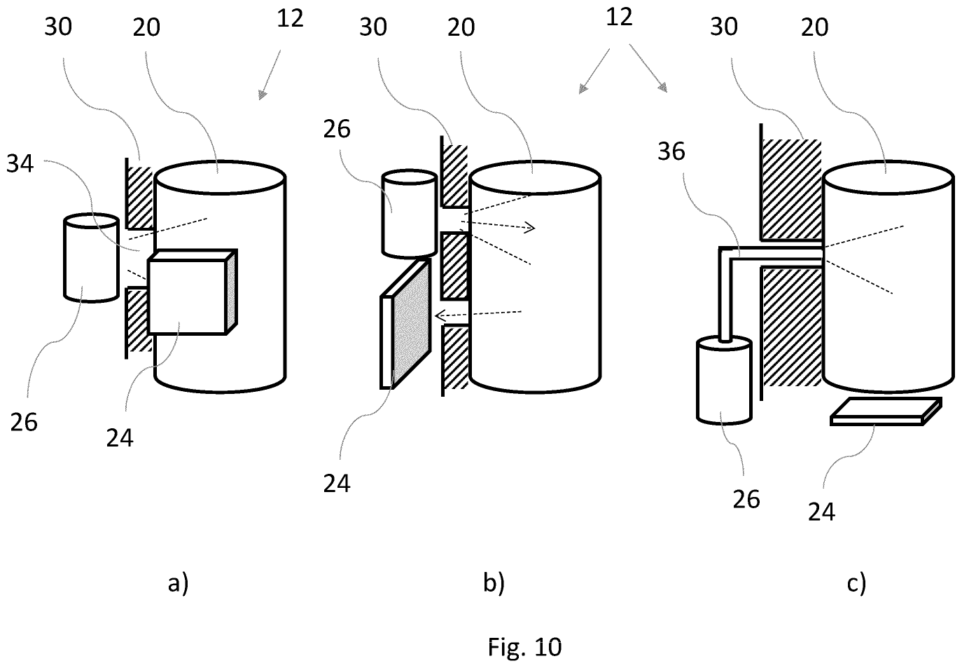

FIG. 10a-c: schematically illustrates alternatives for arranging a light source for illuminating a detection chamber and avoiding a direct light path between the light source an a light sensor;

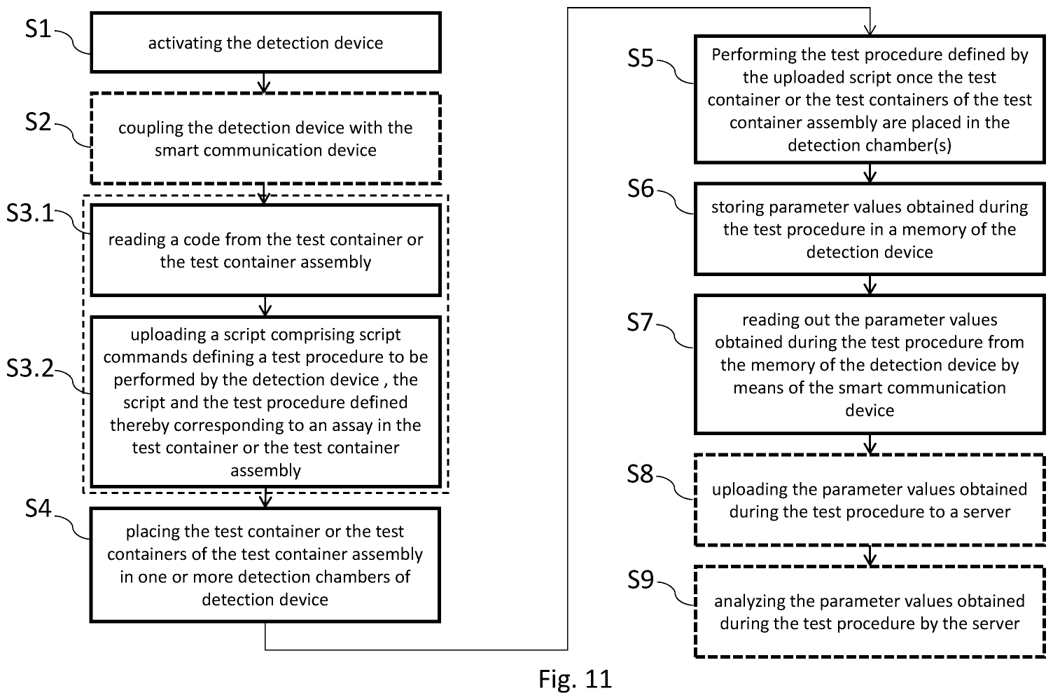

FIG. 11 is a schematic flow chart illustrating a method of operating the test system.

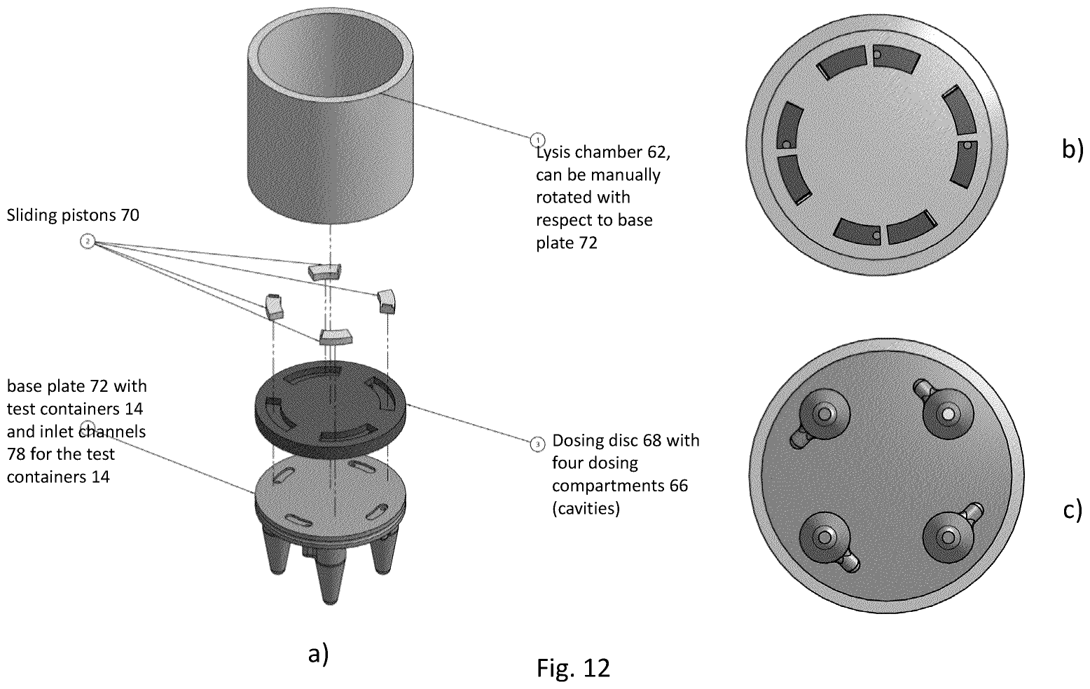

FIG. 12 illustrates a test container assembly comprising a lysing chamber and a dosing assembly with four dosing compartments for transferring definite amounts of fluid from the lysing chamber each of the four test containers;

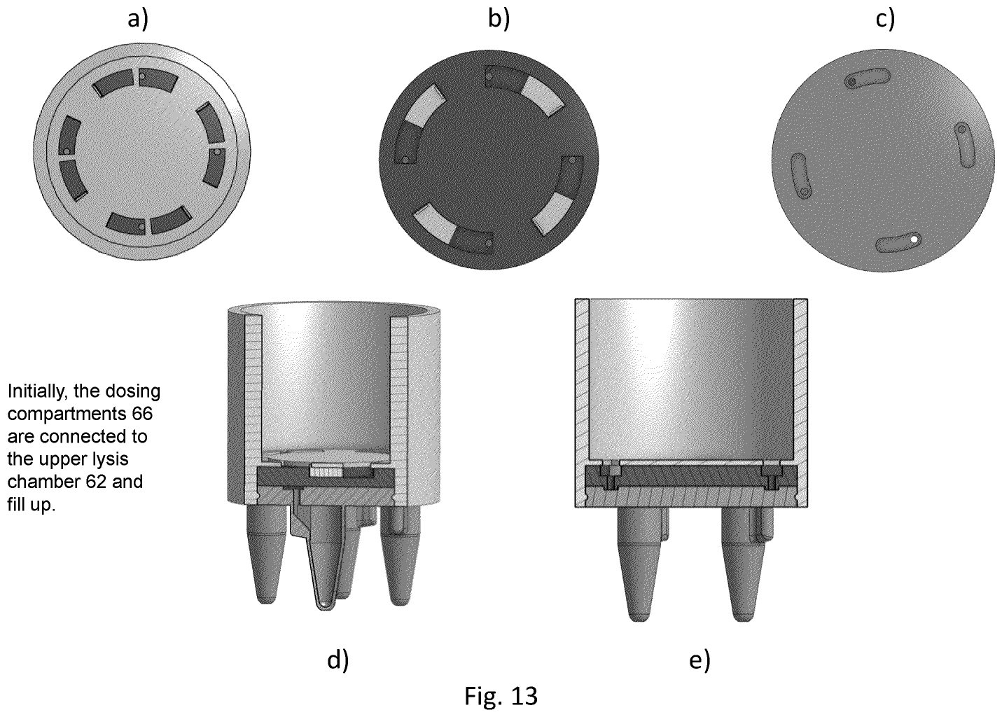

FIGS. 13-16 illustrate the operation of the dosing assembly; and

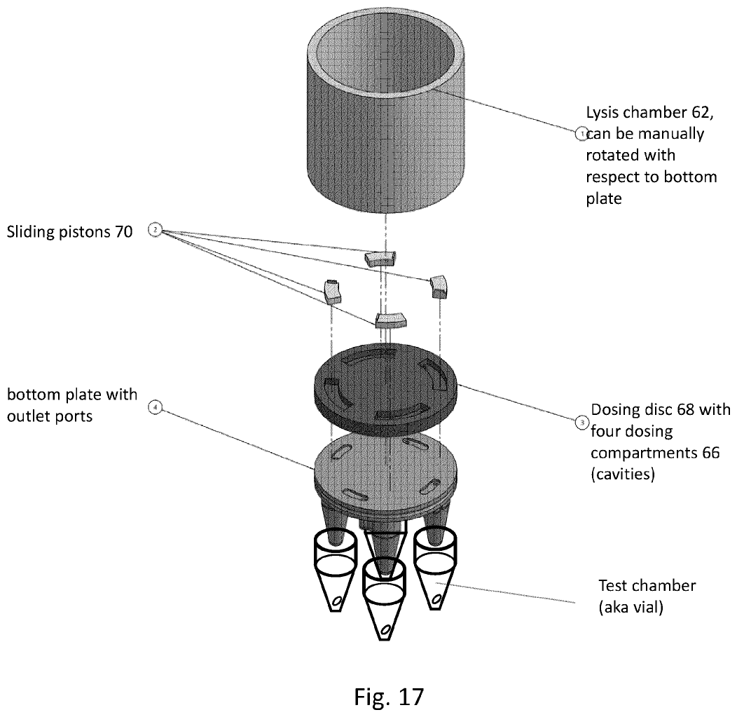

FIG. 17 further illustrates a test container assembly

A test system 10 for detecting a target analyte in a sample comprises a detection device 12, one or more test containers 14, a smart communication device 16 and preferably a central server 18 that can communicate with multiple smart communication devices 16 and multiple detection devices 14; see FIG. 1.

The detection device 12 comprises multiple receptacles 20 that are configured for each receiving a test container 14; see FIG. 2. Each receptacle 20 is defining a detection chamber of the detection device 12.

Preferably, the test containers 14 are part of a test container assembly 22 that comprises a plurality of test containers 14; see FIGS. 2 and 3. The test containers 14 of the test container assembly 22 are arranged in a fixed geometric constellation that matches a geometric constellation of the receptacles 20 of the detection device 12; see FIG. 2. Thus, all containers 14 of the test container assembly 22 can be placed in the receptacles 20 of the detection device 12 simultaneously thus allowing simultaneous tests of a sample, for instance for different target analytes. In particular, the detection device simultaneous testing of samples contained in different test containers.

### Detection Device

The detection devise 12 is configured to excite and detect luminescence in a sample contained in a test container 14 placed in a receptacle 20 of the detection device 12.

In the schematic representation of the detection device 12 in FIGS. 4 to 8 the basic components of the detection device 12 are shown: for each receptacle 20 an optical sensor 24 is provided that preferably can detect light in different bands of wavelengths. Each optical sensor 24 can be configured to either detect light intensity over a broad range of wavelengths or discriminate between different bands of wavelengths to thus gather spectroscopic information.

Preferably, for each receptacle 20 an individual light source 26 is provided for illuminating the contents of a test container placed in the respective receptacle; see FIG. 5. Alternatively, a common light source 26′ for all receptacles 20 can be provided; see FIG. 4.

The optical light sources 26 and the light sensors 24 for each receptacle 20 are arranged so as to prevent light emitted by the respective light source 26 from directly illuminating a respective light sensor 24. In other words: there is no direct light path between the light sources 26 and the light sensors 24. Therefore, only light that is scattered by a sample in a test container or luminescence generated in a sample in the test container is sensed by each light sensor 24.

FIGS. 10a, 10b and 10c illustrate different preferred arrangements of light sources 26 and light sensors 24 in more detail hereinafter.

Each light source 26 is configured to emit light in different bands of wavelengths. Among this bands of wavelengths is a band of wavelengths that can excite luminescence in a sample contained in a test container 14 if light in that band of wavelengths illuminates the sample.

Light in further bands of wavelengths allows to detect for instance turbidity of a sample in a test container 14.

Further, heating means 28 are provided for heating walls of receptacles 20. Preferably, receptacles 20 are arranged in a common metal block 30 that is heated. The metal block 30 provides for a uniform heat distribution and thus a homogenous temperature in all receptacles 20. The heating means 28 preferably are electric heating means that are temperature controlled. Preferably, a feedback temperature control is provided that is connected to at least one temperature sensor 32. The temperature sensor 32 preferably is arranged in the center of the metal block 30 that is surrounding the receptacles 20.

Each receptacle 20 defines a detection chamber that can be heated and illuminated for the exciting and detecting luminescence.

In an alternative embodiment (not shown) individual heating means for each receptacle 20, i.e. for each detection chamber may be provided thus reducing the thermal mass to be heated by one heating means.

Preferably, a common thermal mass as provided by metal block 30 is provided. The thermal mass-and thus the thermal capacity-of metal block 30 preferably is at least ten times larger than the thermal capacity of the sample fluid in all test containers 14 placed into receptacles 20 together.

The electric components described so far—i.e. light sensors 24, light sources 26, heating means 28 and temperature sensor 32 are connected to a controller 40 and a power source 42. The power source 42 preferably is a rechargeable battery. The controller 40 and the power source 42 are preferably connected to or part of a control module 44 that is electrically connected to the electric components 24, 26, 28 and 32 by flexible electric conductors, for instance a flexible printed circuit boards (flexible PCBs) or flexible wires to thus limit a heat transfer between the control module 44 and the electric components arranged around the receptacles 20, i.e. the light sensors 24, the light sources 26, the heating means 28 and the temperature sensor 32.

The controller 40 is further connected to a memory 46 and a wireless data transmission interface 48. Controller 40 further is connected to a light source driver circuit 50, a light sensor sub-controller 52 and a heating means feedback controller circuit 54. The controller 40 is connected to memory 46, to wireless data communication interface 48, to light source driver circuit 50, to light sensor sub-controller 52 and to heating means feedback controller circuit 54 via a data bus 56, preferably an I2C bus. Controller 40, memory 46, wireless data communication interface 48, light source driver circuit 50, light sensor sub-controller 52 and heating means feedback controller circuit 54 are preferably arranged on a common printed circuit board (PCB, main board) that is part of the controller module. Light sources 26, light sensors 24, heating means 28 and temperature sensor 32 are preferably connected to the main board by flexible circuit boards or flexible wires.

The heating means 32 preferably comprises a conductor that is arranged in a meander shape or a spiral shape and that acts as a heating wire.

The light source driver circuit 50 is configured to enable controlling of the light sources 26 by the controller 40. Controlling the light sources includes controlling eth intensity of the emitted light in one or more bands of wavelengths. In the simplest case, controlling of the light source is a simple on-and off-switching of the light sources 26.

Light sensor sub-controller 52 is configured to enable a read-out of the respective light sensors 24 by the controller 40 to thus acquire light sensor output signals that can be processed by controller 40.

The heating means feedback controller circuit 54 is configured to control the heating means 28 and to be controlled by controller 40. The heating means feedback controller circuit 54 is electrically connected to the at least one heating means 28 for heating the receptacles 20. The heating means feedback controller circuit 54 may also be connected to the temperature sensor 32. The heating means feedback controller circuit 54 may implement a feedback temperature control for heating the receptacles to e temperature set by controller 40 and controlling the temperature. Alternatively, the heating means feedback controller circuit 54 may provide an interface for connecting the temperature sensor to controller 40 and driver electronics for controlling the heating means 28 by the controller 40. Temperature feedback control then could be defined by a temperature control software program stored in memory 46.

Memory 46 at least comprises a detection device operating system, i.e. control software that is executed by the controller 40 during operation of the detection device 12.

Further, a status light, preferably a RGB light emitting diode (LED) 38 is provided that is controlled by controller 40 via an LED driver circuit 38.1. Controller 40 is configured by means of the device operation system to cause the LED indicating different light codes, for instance causing the LED to be lit in different colors or with different blinking codes. Each light code represents a predefined status of the detection device or a different events.

The housing 34 of the detection device preferably is fully closed except for a USB terminal and the openings of the receptacles 20; see FIG. 6. Further, the status indicating light 38.1 is visible from the outside. A closure (not shown) for the openings of the receptacles 20 may be provided to prevent light from entering the receptacle when no test containers as placed in the receptacles or some of the receptacles 20.

The operation system stored in memory 46 comprises at least the following software components:
a basic, autonomous device operating system
a temperature feedback control program
a self test program
a script interpreter for script commands received from a smart communication device and
a data communication program

Via the wireless data transmission interface 48, detection device 12 can communication with a smart communication device 14 such as, for instance, a smartphone. On the smart communication device 16 an application (i.e. software program) is installed that enables communication with the detection device 12 and provides a user interface for controlling the detection device 12 and for displaying information about the detection device 12 and received from the detection device 12 to a user. The user interface of the smart communication device 16 preferably is a graphical user interface.

According to a preferred embodiment functions provided by the detection device operating system and the controller 40 of the detection device 12 independently from the smart communication device 16 are the following functions:
power-up and power down
self test
script interpreter

In addition thereto, the application installed on the smart communication device 16 provides for the following additional functions:
detection device configuration via scripts and script commands
detection device soft-and firmware update
user interface with prompts for the user
control of the detection device via script commands during test procedure
read-out of data from the detection device memory 46
communicate with server 18

Due to the functions split between the detection device 12 and the smart communication device 16 the detection device can be implemented as a universal low cost device that provides basic functions for luminescence excitation and detection in a sample.

By means of the smart communication device 16 and/or the server 18, detection device 12 can be remotely configured for different test procedures. In particular, in the server 18 and/or in the smart communication device 16 parameters for different test procedures can be stored so that they can be transmitted to a detection device 12. The latter aspect is supported by the script interpreter that is installed on the detection device 12. The detection device 12 thus can interpret scripts and operate according to script commands. The script interpreter is configured to interpret a limited number of script commands. This is a security aspect because thus the detection device 12 can not be freely programmed. Rather, the script commands in combination with the script interpreter are configured to ensure an operation of the detection device 12 within the design limits.

By means of script commands, entire test procedures can be defined so that they can be executed by the detection device 12. In particular, different test procedures for different target analytes can be provided and defined by scripts.

### Method for Operating the Test System and a Test Procedure:

Typically, a method for operating the test system and a test procedure comprise at least some of the following steps:

Initially, a detection device 12, a smart communication device 16 and a test assembly 22 are provided.

The detection device may need to be charged. For charging, the detection device 12 is connected to a typical charging device.

Once the detection device 12 is charged, it can be switched on. The detection device 12 then carries out a self test. According to a preferred embodiment, all receptacles (detection chambers) 20 of the detection device are covered during the self test.

At the end of the self test, the detection device is prepared to be connected to a smart communication device 16. Readiness of the detection device 12 is indicated by the color status light, for instance RGB LED 38. A wireless data connection between the smart communication device 16 and the detection device 12 can be initiated by arranging the smart communication device 16 in close distance to the near field communication chip 48.1 of the detection device 12. In the memory of the NFC chip 48.1, a Bluetooth connection ID is stored that then is transmitted to the smart communication device and enables the smart communication device to establish a Bluetooth data communication between the smart communication device 16 and the detection device 12. Accordingly, a Bluetooth connection between the smart communication device 16 and the detection device 12 is established via tab-to-connect.

Further, on the memory of the NFC chip 48.1, a link for an application to be installed on the smart communication device 16 may be stored. The link may also be transmitted to the smart communication device 16 via near field communication. Thus, an application for operating the detection device 12 can easily be installed on the smart communication device 16.

The application also enables the smart communication device 16 to connect to a server 18.

To configure the detection device 12 for performing a specific test procedure, the smart communication device 16 is used to read a code from the test container assembly 22. The code to be read can be a graphical code, for instance a QR code or a barcode or any other sort of matrix code. A code could also be a code stored on an NFC chip attached to the test container assembly 22. The code contains at least an idea of the assay or the assays provided with the test containers 14 of the test container assembly 22. Based on the code read from the test container assembly 22, the app running on the smart communication device 16 initiates the transfer of a script defining a suitable test procedure from server 18 to detection device 12. In other words, for each assay or for each combination of assays, specific test procedures are defined. For configuring the detection device 12 for performing the specific test procedures, scripts are stored either on server 18 or on smart communication device 16 that can be interpreted by the script interpreter of the detection device and that configure the detection device 12 for performing the steps of the individual test procedure.

Initially, no test procedure is defined on the detection device. As a matter of safety, scripts defining test procedures are not stored on the detection device 12 after a test procedure is finished.

The script defines for instance the timing of the steps of the test procedure, the values to be measured, the control of the light sources 26, the storing of measured parameter values and the triggering of messages that are shown to a user on a display of the smart communication device 16. The messages to be shown to a user are defined by the application installed on the smart communication device 16. Display of these messages can be initiated by commands received from the detection device 12 during a test procedure.

The script commands can further define color and/or blinking codes of the data slide 38 during different stages of a test procedure. For instance, a dedicated color and/or blinking code of data slide 38 may indicate to a user the end of a test procedure independently from a message shown to the user on the display of the smart communication device 16.

Parameter values measured for instance by light sensors 24 of the detection device 12 during a test procedure and further parameters, like temperature values during the test procedure or light intensities during the test procedure are stored in memory 46 of the detection device 12. Preferably, all stored parameter values are encrypted.

Once the test procedure is finished, parameter values stored during the test procedure can be read out by means of the smart communication device 16 and can be transmitted to the server 18. However, parameter values are stored in memory 46 of detection device 12 together with a test procedure ID or an assay ID as long as these parameter values are not read out by smart communication device 16. In other words, there is no need to read out the stored parameter values during or immediately after a test procedure. Rather, parameter values can be read out later on.

The script interpreter and the detection device operating system are part of a firmware of the detection device 12. Updating the firmware of detection device 12 can also be performed by means of a smart communication device 16 and the application installed thereon.

All test procedures to be performed by detection device 12 preferably are configured to require no more than 15 minutes of time, preferably no more than 10 minutes or even less than 5 minutes. The duration of a test procedure can be optimized, because the test procedure is always individually adapted to the specific assays. Therefore, the combination of specific assays contained in test containers 14 and optimized test procedures for each assay provide for short test procedures.

The detection device 12 in combination with a smart communication device 16 or a server 18 is configured for central management of a plurality of detection devices by means of the central server. The central server 18 allows for instant quality assessment by comparing data received from different detection devices 12. Further, data measured by an individual detection device 12 can be compared with data measured by other detection devices 12 applying the same test procedure. This allows for clustered evaluation of the data thus gathered by different devices.

Further, this enables an implicit control of the test because the test results (data acquired by the detection device 12) can be compared with reference data collected by other detection devices. In case measured data significantly deviate from reference data stored on server 18, a warning might be generated indicating to the user that the test might have failed.

Since the data generated by the detection device 12 can be transmitted to the smart communication device 16 and/or the central server 18, a test history log can be generated and stored.

Further, the app on the smart communication device preferably is configured to provide feedback to a user during use. In particular, the app can be configured to instruct a user step by step regarding all manual steps the user has to execute during a test procedure.

The smart communication device 16 may also be configured to generate a note at the end of the test procedure reminding the user to dispose a sample after the test in a correct manner.

Yet another aspect relates to the test containers 14 and the chemicals contained therein. Indication to the chemicals contained in test containers 14 and, for instance, their production date can be attached to each test container assembly 22 for instance by way of some sort of graphical code like QR-Codes or barcodes or the like. Such code can be read out by a smart communication device 16. The smart communication device 16 may then transmit a script to the detection device 12 for configuring the detection device 12 in a manner that suits the chemicals in the test containers 14 of test container assembly 22.

Further sensors of the detection device 12 not yet mentioned are a position sensor or a posture sensor, a humidity sensor and a temperature sensor for the external environment temperature. Ambient (environment) temperature may be also determined indirectly during heating of the detection device 12 by measuring the energy needed to heat the detection device 12 to a certain temperature.

The system 10 preferably is a decentralized system with a plurality of independent detection devices 12. Each detection device 12 is a reusable low cost device that facilitates multi use with low cost disposables. The low cost disposables can for instance be test container assemblies like test container assembly 22.

Preferably, the detection device 12 has no buttons and can be completely controlled via an external device such as the smart communication device 16. This makes the detection device 12 more robust and avoids contaminations. The housing 34 of the detection device 12 is fully closed except for a USB terminal and the openings of the receptacles 20

A typical method of operating the test system comprises at least some of the following steps:
powering-up the detection device 12, preferably initiated by a user by way of the smart communication device 16,
booting the detection device 12, initiating sensors and actors (heating means and light sources), starting device OS, starting script interpreter
automatic self testing of the detection device 12,
coupling the detection device with the smart communication device 16,
reading a code representing an assay ID from the test container assembly by means of the smart communication device 16,
loading a script defining a test procedure configured to suit the assay(s) contained in the test containers from the server via the external smart communication device 16,
uploading the script comprising script commands to be interpreted by a script interpreter to the detection device memory 46,
performing a test procedure according to the script commands received from the server 18 and stored in memory 46,
heating up (automatic, without user interaction) the detection chambers 20 of the detection device 12,
prompting the user to insert test containers 14 in the receptacles 20 (prompting via external smart communication device 16),
automatic detection of inserted test containers 14, for instance by way of detecting events in the light sensor output signal,
starting illumination and measurements according to procedure defined by a script stored in memory 46 of detection device 12,
store sensed light parameter values as obtained from the light sensor output signals,
checking data integrity,
observing user interactions,
generating and signaling warning messages in case of malfunction or wrong user interactions (for instance removal of the test containers or wrong posture of the detection device),
indicate sensed/non-sensed luminescence to the user either via a status indicating light 38.1 of the detection device (less preferred) or by way of a message shown on a display of the smart communication device 16 (preferred) or both,
informing the user about a successfully finished test procedure or a failed test, respectively,
reading out sensed light parameter values as stored in the memory 46 of detection device 12,
transmit data representing light parameter values via smart communication device to server 18,
evaluate the data representing light parameter values.

A method of operating the test system as illustrated in FIG. 11 comprises the steps of:
providing a detection device according to one of those described herein,
providing a test container or a test container assembly as describe hereinafter,
providing a smart communication device,
activating the detection device (S1),
if needed, coupling the detection device with the smart communication device (S2),
configuring the detection device or a test procedure (S3) by
   reading a code from the test container or the test container assembly (S3.1),
   uploading a script comprising script commands defining a test procedure to be performed by the detection device, the script and the test procedure defined thereby corresponding to an assay in the test container or the test container assembly (S3.2) and
placing the test container or the test containers of the test container assembly in one or more detection chambers of detection device (S4),
automatic start of the test procedure defined by the uploaded script once the test container or the test containers of the test container assembly are placed in the detection chamber(s) (S5),
storing parameter values obtained during the test procedure in a memory of the detection device (S6),
reading out the parameter values obtained during the test procedure from the memory of the detection device by means of the smart communication device (S7) and
uploading the parameter values obtained during the test procedure to a server (S8).

Steps in blocks defined by dashed lines in FIG. 11 are optional or preferred, respectively.

According to preferred embodiments, the detection device may have further sensors in addition to the light sensors 24. As an optional further sensor preferably a temperature sensor 32 is provided because temperature sensor 32 enabled feedback control of the temperature. Further sensors not shown in the figures and possibly be implemented with the detection device 12 are an inertia measurement unit for determining the orientation or posture of detection device 12 and a humidity sensor that can sense the humidity of the air in the environment of the detection device 12. Output signals generated by these sensors are preferably also stored in memory 46 of detection device 12.

Preferably all data representing measured parameter values and/or events are transmitted to server 18. In a preferred system, a plurality of detection devices 12 can be administrated by one server (or one group of servers) 18. Thus, server 18 is capable of analyzing data representing measured parameter values from different detection devices 12. Since the data received by server 18 during or after a test procedure not only contains data representing measured parameter values but also some sort of assay ID, server 18 can be adapted to analyze corresponding measured parameter values from different detection devices relating to the same kind of assay. Thus, it is possible, to further optimize the test procedure for each assay and to generate scripts with script commands accordingly. The optimized test procedures for each assay as represented by the particular scripts minimize the risk of failed tests or wrong user manipulation. Further, the adaptation of the test procedure to each particular assay makes short test procedures possible. For instance, a test procedure is shorter than 15 minutes, preferably shorter than 10 minutes or even shorter than 5 minutes.

The script interpreter of the detection device defines a detection device specific script language. The script language is designed to limit the effect of script commands for instance with respect to controlling the sensors of the detection device or the heating means and/or the light sources such that all components will always operate within their specific design limits. Thus, improved device security is achieved through limited script commands.

Server 18 or a group of servers 18 comprises a data base wherein for each assay a specific test procedure and a script corresponding to the specific test procedure is stored. Therefore, a specific script can easily be downloaded from the server once the smart communication device requests a script for a specific assay ID.

Providing a central server 18 also has the advantage of allowing a central management of all detection devices and of performing a continuous quality assessment. Data representing measured parameter values as received from different detection devices can be analyzed by way of cluster evaluation which further improves the sensitivity and the specificity of the test as defined by each particular test procedure.

Data generated by server 18 can be made available to the application installed on a specific smart communication device. Thus, the smart communication device can perform an implicit control of each test while being coupled to a detection device during the test.

However, since the detection device 12 has sufficient memory 46, detection device 12 can also operate autonomously in case the data communication between the detection device 12 and the smart communication device 16 is interrupted during a test procedure. Measured parameter values stored in memory 46 of detection device 12 can be read out anytime later, for instance hours or days after the test procedure was finished.

The application installed on the smart communication device 16 preferably is configured to provide user feedback during each test procedure. In particular, the application is configured to provide step by step instructions to the user and to inform the user about the specific state of the detection device or the results of a test performed by means of the detection device. The application installed on the smart communication device 16 may also prompt the user at the end of the test to dispose the test container assembly 22 in a safe manner.

As already indicated, among the parameter values measured during a test procedure is temperature. The temperature values typically relate to the temperature in the detection chambers 20. However, taking into account the power consumed by heating means 28 and the temperature values measured during heating, also the temperature of the environment can be determined by analyzing the time course of the temperature values in relation to the power consumed by the heating means. Instead of providing a dedicated temperature sensor for the environment temperature, environment temperature can thus be indirectly determined by means of the temperature sensor for the detection chambers 20.

Preferably, the power requirement of the detection device 12 is less than 10 W (Watt). The weight of the detection device preferably is less than 250 grams and even more preferred less than 100 g or less than 50 g. Preferably, the overall volume of the detection device is less than 250 cm³.

FIGS. 10a, 10b and 10c illustrate ways to prevent that light emitted by a light source 26 can directly illuminate the light sensor 24 of a respective receptacle 20.

As shown in FIG. 10a, a light source 26 and a light sensor 24 can be arranged laterally with respect to a receptacle 20 at an angle that prevents the light emitted from light source 26 from directly illuminating the corresponding light sensor 24. The angle can for instance be 90°. Walls, for example walls of metal block 30 have a lateral aperture 36.1 that directs light from light source 26 into receptacle 20 and prevents direct illumination of light sensor 26.

Another preferred arrangement of light source 26 and corresponding light sensor 24 is shown in FIG. 10b. Accordingly, light source 26 and light sensor 24 are arrangement on the same side of the receptacle 20 above one another. Thus direct illumination of the light sensor 24 by the light source 26 is avoided.

Alternatively, as shown in FIG. 10c, light source 26 and light sensor 24 can be placed on the same level, for instance on a printed circuit board, for instance a daughter board for the light sensors and the light sources that is flexibly connected to the main board that carries the controller 40 et al. Then, light from light source 26 can be guided by a light guide 36.2 and fed laterally into receptacle 20. The embodiments of FIG. 10a or 10b, however, are preferred because the lateral arrangement of light sources 26 and light sensors 24 is less affected by particles settling on the bottom of the test container.

### Test Container Assembly With Dosing Means

FIGS. 12 to 17 illustrate a test container assembly 22 with dosing means 60 according to a second aspect of the invention. The test container assembly 22 comprises a single lysing chamber 62 and dosing means 60 for dispensing a definite amount of fluid from the lysing chamber 62 to individual test containers 14. The lysing chamber 62 contains a liquid lysing fluid that causes lysing of the cells in a sample to thus release the nucleic acids (DNA or RNA) is provided. The lysing fluid may comprise an acid, e.g. HCl or a weak alkali, and a surface active agent.

Each test container 14 contains a mixture of chemicals that can cause an amplification of nucleic acid in a sample. Preferably, the mixture comprises including target-specific probes and enzymes, in particular a recombinase, a single-stranded DNA-binding protein (SSB) and strand-displacing polymerase that causes a recombinase polymerase amplification (RPA). The test container further preferably contains exonuclease III allowing the use of an exo probe for real-time, fluorescence detection. The mixture may be provided in form of a dry pellet 64.

According to a preferred embodiment, one of containers 14 contains a reference or control assay that always will cause luminescence if the test system is handled correctly and the test procedure is performed without faults.

Dosing compartments 66 of the dosing assembly 60 each preferably have at least one flow-in opening and at least one flow-out opening. The flow-in opening and the flow-out opening can be selectively closed and opened. The dosing assembly comprise manually operated control means for selectively opening and closing the inflow openings and the outflow openings.

The dosing means preferably are integrated in the container assembly 22 comprising the lysing chamber 62.

The dosing means may comprise a dosing disc 68 that can be rotated. In one rotational position of the dosing disc 68 the dosing compartments 66 are open towards the lysing chamber 62 and in a different rotational position of the dosing disc 68 the dosing compartments 66 have open outflow openings so as to release the contents of the dosing compartments 66 towards the different test containers 14.

The number of dosing compartments 66 corresponds to the numbers of test containers 14 of the test container assembly 22.

If for instance four detection chambers 20 and thus four test containers 14 are provided, dosing disc 68 of the dosing assembly 60 may be configured to be rotated by a little less than a quarter of a full turn.

In one embodiment, the dosing compartments 66 are additionally fluidly connected with respect to the lysing chamber 62, i.e. the dosing compartments are open towards the lysing chamber 62. In order to achieve a homogenous distribution of the sample in the lysing chamber 62 and the dosing compartments 66, it is preferred if the dosing compartments 66 each have a large opening towards the lysing chamber 62.

In an alternative embodiment, the dosing compartments initially are fluidly separated from the lysing chamber. After lysing, the dosing compartments are fluidly connected to the lysing chamber. For example, a rotating or otherwise moving part of the dosing assembly would open a fluid connection between the lysing chamber and each dosing compartment. For instance, the lysing chamber with respect to the dosing compartments can be rotated in a position wherein an outflow port of the lysing chamber is in line with an inflow opening of a respective dosing compartment.

According to different preferred embodiments, rotation may be caused by manual actuation or by a motor in the testing device. The rotation preferably is a quarter turn if four dosing compartments are provided.

Further rotation would close the fluid connection between the lysing chamber and the dosing compartments and even further rotating would open the outflow opening of the dosing compartments with respect to the test chambers.

The dosing compartments 66 could be cavities and/or openings in a disc-like member of the dosing assembly that is placed between a bottom of the lysing chamber and a bottom of the container comprising the lysing chamber and the dosing assembly.

FIGS. 12 to 17 illustrate a test container assembly 22 with dosing means. The test container assembly 22 of FIGS. 12 to 17 comprises a lysing chamber 62, dosing means 60 and four test containers 14.

The dosing means 60 comprise a dosing disc 68 and four sliding dosing pistons 70.

The dosing disc 68 and the sliding dosing pistons 70 can be rotated or moved, respectively, by turning the lysis chamber 62 with respect to a base plate 72 with outlet ports 74 that are fluid connected to the interior space of test containers 14; cf. FIG. 12a that is an exploded perspective view of the test container assembly 22. FIG. 12b is a top view of the test container assembly 22 and FIG. 12c is a bottom view of the test container assembly 22.

FIGS. 13 to 16 illustrate the steps for transferring a definite amount of fluid from the lysis chamber 62 to each test chamber 14.

Initially, dosing compartments 66 and dosing disc 68 are fluid connected to the interior of lysis chamber 62 as shown in FIGS. 13a to 13e. The bottom of the lysing chamber 62 is in a position wherein openings 74 in the bottom of the lysing chamber 62 are in line with cavities in dosing disk 68 forming dosing compartments 66. Thus, fluid from the interior of lysing chamber 62 can flow into the dosing compartment 66 and fill up the dosing compartment 66. Each dosing compartment has a volume of, for instance, 50 μl. In alternative embodiments, the dosing compartments each may have a capacity between 20 and 100 μl.

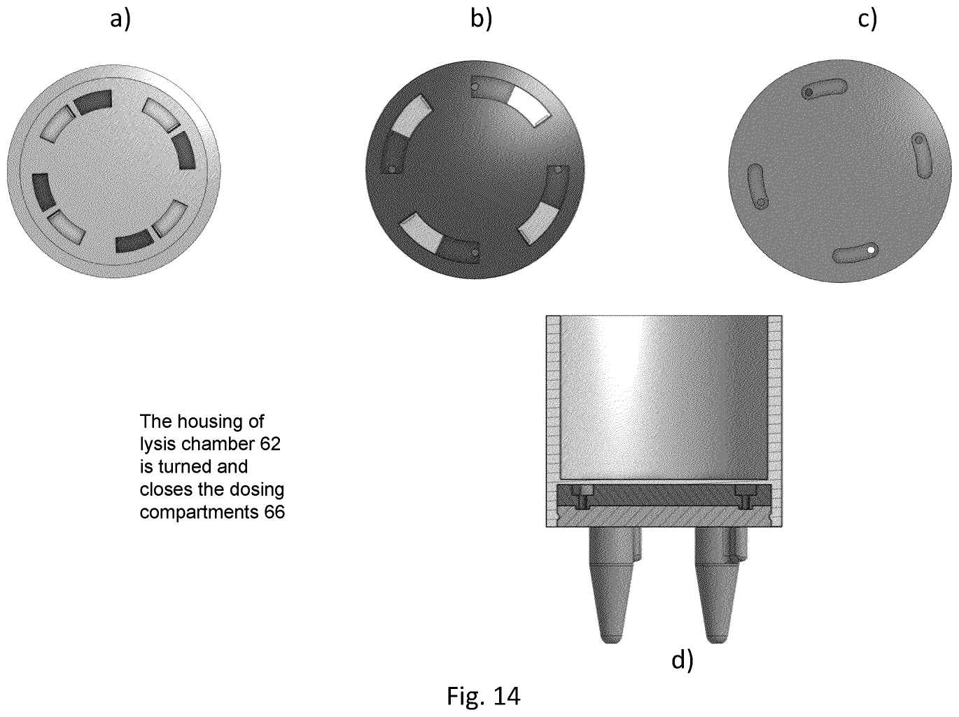

In a next step as illustrated in FIGS. 14a to 14d, the dosing compartments 66 are closed to prevent a further flow of fluid from the interior of the lysing chamber 62 into the dosing compartments 66. Closing the dosing compartments towards the lysis chamber 62 is achieved by turning the lysing chamber 62 counterclockwise-if viewed from above-to a position as shown in FIG. 14a. The dosing disc 68 and pistons 70 maintain each initial position as shown in FIGS. 13b and 14b, respectively. Likewise, base plate 72 does not move at all; see FIGS. 13c and 14c.

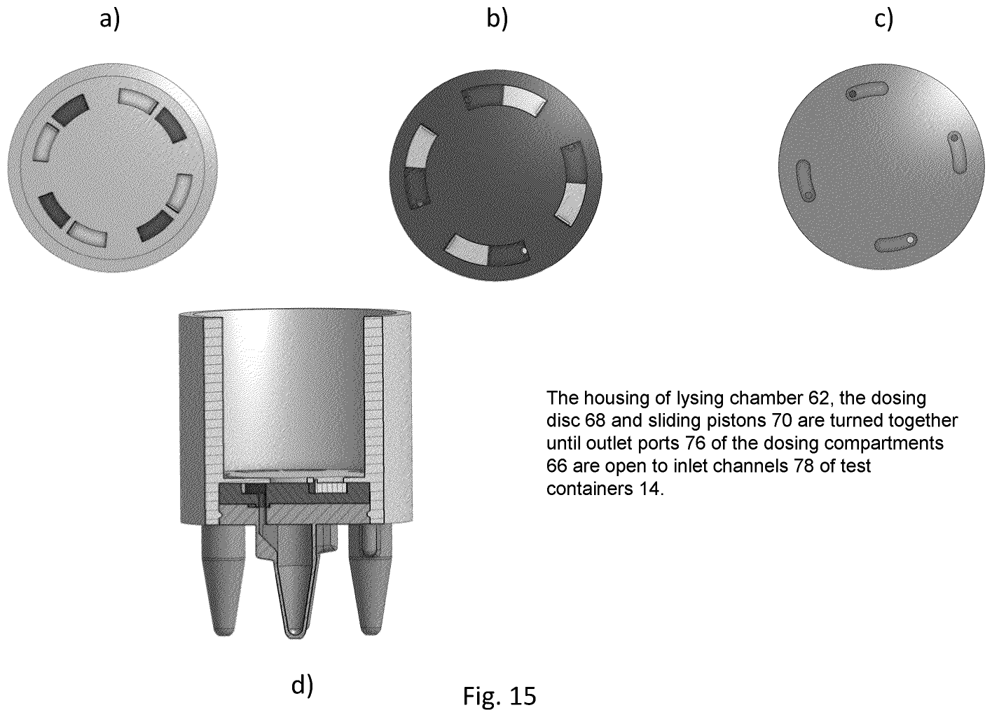

If the lysing chamber 62 is further turned counterclockwise, the dosing disc 68 and pistons 70 are also turned counterclockwise until outlet ports 76 of the dosing compartments 66 are open to inlet channels 78 of the test containers 14 in base plate 72; cf. FIGS. 15a to 15d. Again, base plate 72 has not moved as can be seen in FIGS. 13c, 14c and 15c while both, the lysing chamber 62 and the dosing disc 68 with pistons 70 are rotated with respect to their previous position that is shown in FIGS. 13a and 13b; cf. FIGS. 14a and 14b.

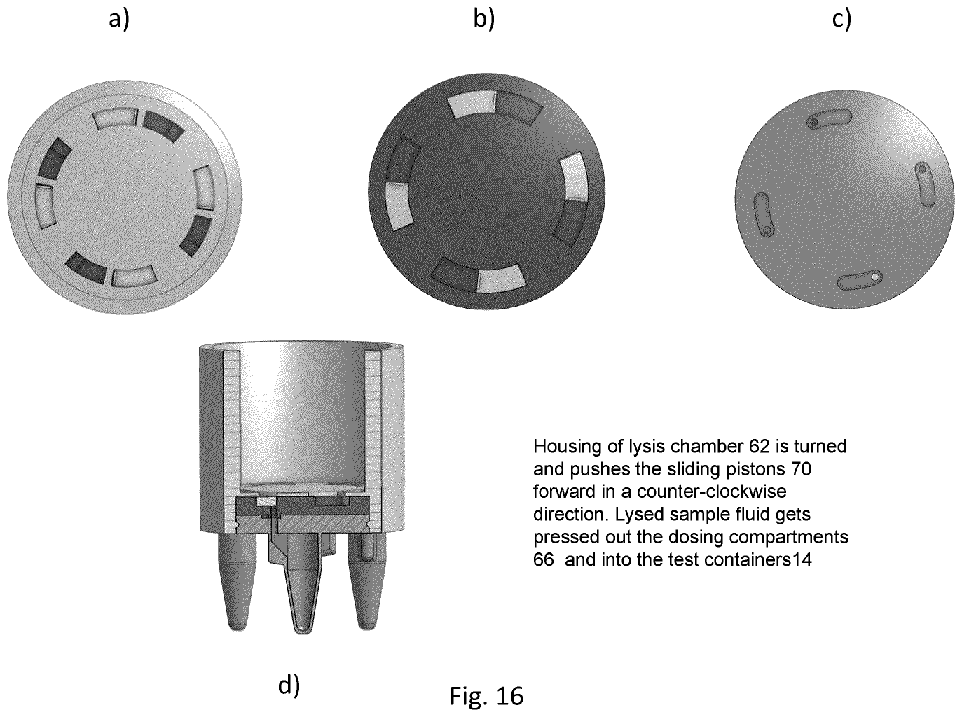

Finally, as shown in FIGS. 16a to 16d, the contents of the dosing chambers 66 is pressed out of the dosing chamber 66 and into the test containers 14 by means of the sliding pistons 70. This is achieved by further turning lysing chamber 62 counterclockwise. This rotation of the lysing chamber has the effect of pushing the sliding pistons in a counterclockwise direction while dosing disc 68 does not further rotate; see FIGS. 16a and 16b. Further rotation of dosing disc 68 is prevented by an abutment (not shown). Thus, the entire contents of dosing chambers 66 is transferred into test containers 14 while fluid still remaining in lysing chamber 62 is prevented from flowing into any of the test containers 14.

FIG. 17 is similar to FIG. 12a and illustrates that base plate 72 of test container assembly 22 is interconnected to four test containers 14 each comprising a dry pellet with chemicals and biochemicals, in particular enzymes.

The test container assembly 22 described herein is particularly suitable for a use with a detection device 12 as described herein since the test container assembly 22 facilitates a simultaneous start of different chemical and/or bio-chemical reactions in the test containers 14 thus allowing an easy comparison of time courses of signals generated by the sensors in the different detection chambers of the detection device where the test containers are placed in.

It is noted, however, that the detection device 12 can be used independently from the test container assembly 22 described herein and vice versa. In particular, the detection device 12 may be used with other test container assemblies or even with individual test containers. The number of test containers placed in the receptacles 20 of the detection device may even be smaller than the number of receptacles. Accordingly, even a sample in a single vial can be analyzed with the detection device.

The fluorescence detection device 12 comprises a plurality of detection chambers 20, for instance four detection chambers, mating the test containers 14 of the test container assembly 22. Each detection chamber 20 is configured to receive a test container 14. Within a respective detection chamber 20 or adjacent to the detection chamber, a light source 24 and an optical sensor 26 are arranged. The light source 24 is configured to illuminate the contents of the respective detection chamber 20 with a light that can cause luminescence in a sample to be tested during and after the sample has undergone recombinase polymerase amplification. The optical sensor 24 is arranged and configured to detect luminescence in the detection chamber 20 in case luminescence occurs. For each detection chamber 20, an individual optical sensor 26 is provided. For illuminating the contents of the test containers 14 placed in the different detection chambers 20, a common light source light source 26′ may be provided: Alternatively, individual light sources 26 for each detection chamber may be provided.

The detection chambers 20 preferably are equidistantly arranged in a rotation-symmetric manner.

FIG. 9 illustrates basic electronic components of the detection device 12. To power up the light source(s) 26 and the optical sensors 24, an energy supply 42 is provided, see FIG. 9. The energy supply 42 may comprise a battery, preferably a rechargeable battery. Alternatively or additionally, energy supply 42 may comprise a power interface for connecting the fluorescence detection device 12 to an external power supply. The power interface may be wire-bound or wireless. The energy supply 42 may also comprise solar cells for providing photovoltaic power supply.

The light source 24 and the optical sensor 26 are further connected to controller 40 that is configured to control the operation of the light source 24 and the optical sensor 46 and to further read out a sensor output signal provided by the optical sensor 26. Controller 40 can be a microcontroller or a state machine.

The controller 40 is operatively connected to a wireless data interface 48 that is configured to allow for a data communication between the microcontroller 40 and an external device such as a mobile phone or another device for data communication and data processing.

Preferably, the wireless data interface 48 is operatively connected to the controller 40, to the energy supply 42 and to a data memory 46 and is configured to provide for energy harvesting, data storage and data communication. In particular, the wireless interface 48 implements means for near field communication (NFC) and comprises a data bus such as a I2C data bus 56 for communication with the controller 40. The wireless data communication interface 48 preferably is configured to allow bidirectional data communication so as to transmit data generated by the fluorescence detection device 12 to an external device and to receive the control commands and/or software updates from an external device, for instance a smart communication device, so that the fluorescence detection device 12 can be controlled and updated by way of an external device.

The wireless data interface 48 may also implement WIFI-communication as an alternative to near field communication. Another alternative is Bluetooth-communication.

The wireless data communication interface 48 that is configured for transmitting data via NFC or RFID, preferably, comprises one or more antennas 58 functioning as a radio-frequency (RF) interface for transmitting electromagnetic signals representing digital data by means of electromagnetic induction to one or more further antennas of an external device. Antennas 58 typically comprise one or more coils each having 4 or 5 windings.

The initiator can be the smart communication device 16 providing a carrier field that is modulated by the data communication interface 48 for transmitting digital data. Preferably, for powering the data communication interface 48, the data interface 48 draws energy from the smart communication device 16 via the NFC or RFID link. Thus, in particular, in case the transmitter unit is NFC- or RFID-enabled, it is not necessary that the testing device itself comprises an energy storage unit, e.g., a battery, for powering the data interface 48.

The detection device 12 is a single device allowing receiving test containers 14 with liquid samples as pointed out above. The evaluation whether or not a specific analyte is present in the liquid sample is performed externally, e.g., directly on the smart communication device 16 that receives the digital data from the detection device 12 via wireless data communication interface 48. The smart communication device 16 can be a smartphone, or a tablet, preferably, having at least NFC or RFID capabilities and being configured to function as an initiator device. The smart communication device 16 can also be used to transmit the digital data further, e.g., to a personal computer or a server 18 for evaluation purposes.

Thus evaluation of measurement data generated by the detection device 12 can be processed on one or more servers, i.e. the cloud. Evaluation of measurement data preferably involves the use of trained neural networks on one or more servers.

Test container assembly 14 with dosing means 60 can be used to simultaneously dispense equal amounts of a lysed sample into test containers 14.

### REFERENCE NUMERALS

10 Test system
12 detection device
14 test container
16 smart communication device
18 server
20 receptacle
22 test container assembly
24 light sensor
26 light source
28 heating means
30 metal block
32 temperature sensor
34 housing of the detection device
36.1 aperture
36.2 light guide
   38 status indicating light (RGB LED)
38.1 LED driver circuit
40 controller
42 power source, rechargeable battery
44 control module
46 memory
48 wireless data transmission interface
48.1 NFC transceiver
48.2 Bluetooth transceiver
50 light source driver circuit
52 light sensor sub-controller
54 heating means feedback control circuit
56 data bus; I2C bus
58 antenna
60 dosing means
62 lysing chamber
64 dry pellet with chemicals (enzymes)
66 dosing compartment, cavity in the dosing disc
68 dosing disc
70 sliding pistons arranged in the dosing compartments
72 base plate of the test container assembly
74 openings in the bottom of the lysing chamber
76 outlet ports of the dosing compartments
78 inlet channels for the test containers

1. A test system comprising:
a detection device with a plurality of detection chambers for receiving test containers containing a sample to be tested and a mixture of chemicals including target-specific probes and enzymes that can cause an amplification of nucleic acid in a sample, said detection device further comprising a controller, a memory and a data communication interface, said memory and said data communication interface being operative connected to the controller,
a test container assembly comprising a plurality of test containers containing a sample to be tested and a mixture of chemicals including target-specific probes and enzymes that can cause an amplification of nucleic acid in a sample; and
a smart communication device being configured for wireless data communication with the detection device.

2. The test system according to claim 1, comprising:
a detection device, comprising:
a plurality of detection chambers for receiving test containers;
at least one light source arranged and configured to illuminate at least one detection chamber for causing luminescence in a sample to be tested;
at least one light sensor for each detection chamber configured to detect luminescence in a sample contained in a test container placed in a respective detection chamber;
a controller; and
a memory, wherein:
the light sensors and the at least one light source are arranged to allow illumination of contents of a detection chamber by means of the at least one light source and detecting luminescence in a respective detection chamber by means of the light sensor assigned to the detection chamber while preventing light emitted by the light source or the light sources from directly illuminating any of the light sensors;
the controller is at least indirectly connected to the light source and to the light sensors for controlling the at least one light source and for controlling the read out of output values of the light sensors;
the memory comprises software defining the operation of the controller, and
the memory is adapted to store at least parameter values corresponding to output values of the light sensors.

3. A detection device comprising:
a plurality of detection chambers for receiving test containers,
at least one light source arranged and configured to illuminate at least one detection chamber for causing luminescence in a sample to be tested;
at least one light sensor for each detection chamber configured to detect luminescence in a sample contained in a test container placed in a respective detection chamber;
a controller; and
a memory,
wherein the light sensors and the at least one light source are arranged to allow illumination of contents of a detection chamber by means of the at least one light source and detecting luminescence in a respective detection chamber by means of the light sensor assigned to the detection chamber while preventing light emitted by the light source or the light sources from directly illuminating any of the light sensors,
wherein the controller is at least indirectly connected to the light source and to the light sensors for controlling the at least one light source and for controlling the read out of output values of the light sensors,
wherein the memory comprises software defining the operation of the controller and
wherein the memory is adapted to store at least parameter values corresponding to output values of the light sensors.

4. The detection device according to claim 3:
wherein the memory comprises software defining a script interpreter; and
wherein the detection device is configured to receive script commands that, when interpreted by the script interpreter and executed by the controller, define a test procedure.

5. The detection device according to claim 3, further comprising heating means for controlling the temperature in the detection chambers, said heating means preferably are configured for maintaining a predetermined temperature in the detection chambers within a temperature range of +/−0.5 K about the predetermined temperature, said heating means being controlled by the controller.

6. The detection device according to claim 5, wherein the predetermined temperature is a temperature between 40° C. and 45° C., preferably 42° C.

7. The detection device according to at least claim 5, further comprising a metal block that is thermally coupled to the heating means and that at least in part encloses the detection chambers, said metal block being arranged and configured to provide a uniform heat distribution.

8. The detection device according to claim 3, further comprising a temperature sensor for determining a temperature corresponding to the temperature in at least one of the detection chambers.

9. The detection device according to claim 3, further comprising a wireless data interface for wirelessly transmitting and receiving data to and from a smart communication device.

10. The detection device according to claim 3, further comprising a status indicating light operatively connected to the controller.

11. A method of operating a test system according to claim 1, comprising:
providing a detection device;
providing a test container or a test container assembly;
providing a smart communication device;
activating the detection device;
optionally coupling the detection device with the smart communication device;
configuring the detection device preferably by:
reading a code from the test container or the test container assembly;
uploading a script comprising script commands defining a test procedure to be performed by the detection device, the script and the test procedure defined thereby corresponding to an assay in the test container or the test container assembly; and
placing the test container or test containers of the test container assembly in one or more detection chambers of detection device,
automatically starting of the test procedure defined by the uploaded script once the test container or the test containers of the test container assembly are placed in the detection chamber(s);
storing parameter values obtained during the test procedure in a memory of the detection device;
optionally reading out the parameter values obtained during the test procedure from the memory of the detection device by means of the smart communication device; and
optionally uploading the parameter values obtained during the test procedure to a server.

12. The method according to claim 11, further comprising encrypting the obtained parameter values stored in memory.

13. The method according to claim 11, further comprising deleting script commands in memory once the test procedure is completed.

14. A test container assembly comprising:
a single lysing chamber, a plurality of test containers and dosing means that are selectively fluid connected to the lysing chamber, wherein the dosing means comprise a plurality of dosing compartments for dosed and simultaneous transfer of equal portions of a lysed sample from the lysing chamber into test containers.

15. A test container assembly comprising,
a single lysing chamber, a plurality of test containers and dosing means that are selectively fluid connected to the lysing chamber, wherein the dosing means comprise microfluidic sample distribution means.
